(19) United States
(12) Patent Application Publication
(10) Pub. No.: US 2008/0122311 A1
(43) Pub. Date: May 29, 2008

(54) ROTOR ASSEMBLY AND METHOD OF ASSEMBLING A ROTOR OF A HIGH SPEED ELECTRIC MACHINE

(75) Inventors: Michael D. Werst, Manor, TX (US); Michael C. Lewis, Austin, TX (US); Jon Kitzmiller, Austin, TX (US); Stephen Manifold, Austin, TX (US)

Correspondence Address: BRACEWELL & GIULIANI LLP, P.O. BOX 61389, HOUSTON, TX, 77208-1389, US

(73) Assignee: The Board of Regents, The University of Texas System, Austin, TX (US)

(21) Appl. No.: 11/762,681

(22) Filed: Jun. 13, 2007

Related U.S. Application Data
(60) Provisional application No. 60/813,067, filed on Jun. 13, 2006.

(51) Int. Cl. H02K 1/22; H02K 1/28; H02K 15/02

(52) U.S. Cl. 310/217; 310/262; 29/598

(57) ABSTRACT

A rotor assembly for a high speed electric machine and associated methods are provided. The rotor assembly includes a shaft, a plurality of laminations positioned along an axial extent of the shaft forming a lamination stack, a pair of end plates each positioned on one of the respective ends of the lamination stack, and an internal clamping tube substantially surrounding major portions of the axial extent of the shaft, positioned between the shaft and inner portions of the lamination stack, and contacting the pair of endplates to provide clamping of the lamination stack.

### RELATED APPLICATIONS

This non-provisional application claims priority to and the benefit of U.S. Provisional Patent Application No. 60/813,067, filed on Jun. 13, 2006, incorporated herein by reference in its entirety.

### GOVERNMENT LICENSE RIGHTS

This invention was made with government support under Contract No. 26-3912-03xx awarded by the United States Navy/General Atomics Division. The government has certain rights in the invention.

### BACKGROUND OF THE INVENTION

1. Field of the Invention

The present invention relates to power and power supply source industries and, more particularly, to a rotor assembly and method of assembling a rotor for an electric machine.

2. Description of Related Art

Conventional electric machines such as, for example, electric motors and electric generators, are typically in the form of a rotor connected to a rotatable shaft which rotates within the confines of a stator. These machines use electromagnetic principles to convert mechanical energy into electricity or vice a versa. On relatively small machines, the magnetic field may be provided by one or more permanent magnets. On relatively large machines, the magnetic field is normally created using electromagnets.

These electrical machines are assembled by positioning the rotatable shaft through a central aperture forming a channel extending through the rotor and installing the rotor within a central aperture forming a channel extending through the stator. There are several different methodologies of connecting the rotatable shaft with the rotor. These include, for example, use of an adhesive, use of fasteners, use of a keyed shaft, and use of friction. The use of a keyed shaft and the use of friction are generally preferred in larger electric machines. Of these, the use of friction is preferred over the use of a keyed shaft as it significantly reduces stress concentrations in the shaft and rotor caused by the key, and increases the amount of torque that can be transmitted by the shaft or rotor. There are, however, disadvantages to the use of friction. For example, more care must generally be used during installation to prevent damage to the rotor and to prevent installation errors, which can result in high shaft stresses during high-speed rotation.

There are two primary friction application methodologies for connecting the rotatable shaft with the rotor: the interference press fit method and the thermal shrink fit method. The interference press fit method is essentially accomplished by forcing a tapered shaft into a cylindrical channel or bore. The thermal shrink fit method is essentially accomplished by heating the rotor to expand the size of the cylindrical channel or bore extending through the rotor to allow insertion of the shaft. Recognized by the Applicants, however, is that use of these methodologies, particularly in large electrical machines, limit the ability to disassemble the rotor from the shaft without damaging either the rotor or the shaft.

One phenomenon inherent with such electric machines which utilize changing magnetic fields is the production of eddy currents which transform useful kinetic energy into heat. Such eddy currents generally reduce the efficiency of such electric machines. In order to minimize such currents, various methodologies have been employed including the use of magnetic core materials that have low electrical conductivity, and the use of thin sheets of magnetic or magnetically receptive material, typically referred to as laminations. Larger electric machines generally favor the use of thin sheets of laminations having an insulating material or paint inserted therebetween to aid in inhibiting the circulation of electrons, thereby suppressing the flow of eddy currents. The greater the number of laminations per unit area, i.e., the thinner the laminations, the greater the suppression of eddy currents. With respect to a rotor, the thinner the laminations, however, the more susceptible the laminations are to being damaged during insertion or engagement with the shaft. Recognized by the Applicants is the need for a component and method which would help prevent insertion damage to the laminations. Also recognized is the need for a component and method which would allow for nondestructive removal of the shaft. Further recognized is that a hydraulic assembly fit method, which can be used in inserting a shaft into a relatively solid object having a channel capable of being expanded through the use of hydraulic pressure, would not be suitable for insertion directly into a radially oriented laminate structure, as it would cause separation between and damage to the laminations and/or inter lamination insulating material.

The industry has also recognized that laminations, particularly in rotors, must be clamped to maintain the laminate structure. In the case of the rotor, radial preload is also required to further prevent separation between the lamination stack and shaft at high rotational speeds. Current industry practice is to clamp the laminate together using long bolts (bars threaded on each end) extending through either side of the rotor or stator, respectively. Recognized by the Applicants is that such bolts (holes) disrupt the magnetic flux path and increase stress concentration in the rotor, particularly adjacent to bolts themselves, approximately by a factor of two. Also recognized by the Applicants is that bolt holes through the laminations unnecessarily reduce the amount of magnetic or magnetically receptive material.

### SUMMARY OF THE INVENTION

In view of the foregoing, embodiments of an assembly and methods of the present invention utilize a machine component, such as, for example, a cylindrical tube, positioned, adjacent the laminations, as an interface between a rotatable shaft and a rotor core lamination stack for axial clamping the lamination stack and for providing a protective pathway through the laminations for insertion and extraction of a rotatable shaft. Advantageously, this feature also allows, for example, the lamination stack (axially clamped by the internal tube) to be assembled onto the shaft of an electric machine, e.g., motor or generator, by a variety of methods that include: the interference press fit method, thermal shrink fit method, and tapered hydraulic assembly fit method. Embodiments of an assembly and methods of the present invention also utilize such internal axial clamping tube in conjunction with a pair of end plates to provide a sufficient axial preload to enhance performance and to allow use of the lamination stack (axially clamped by the internal tube) to be used in high power density and high speed electric machines.

Embodiments of an assembly and methods of the present invention also utilize a clamping tube flange in conjunction with a clamping tube nut configured to interface with a pair of end plates to transfer a clamping load from the adjacent tube to the lamination stack to significantly reduce or eliminate the need to put separate holes in the laminations to accommodate bolts or clamping bars. An advantage of this embodiment, for example, is that by significantly reducing or eliminating the holes in the laminations for such clamping bars, there is more magnetic material in the rotor core, and significantly less mechanical stress concentration. Another advantage of this embodiment with respect to rotors is that this embodiment offers the ability to disassemble the laminated rotor stack when, for example, the hydraulic assembly fit method is employed.

Embodiments of an assembly and methods of the present invention also provide for transferring the clamping load from the adjacent tube to the lamination stack via Belleville shaped endplates with a sufficient stiffness profile to maintain a uniform or substantially uniform preload on the lamination stack. Advantageously, such endplates in combination with the clamping tube allow for an axial preload of up to 500 psi or more versus a maximum of approximately 100 psi using conventional methodologies.

More specifically, embodiments of the present invention provide a rotor assembly for a high speed electric machine. For example, a rotor assembly for a high speed electric machine according to an embodiment of the present invention can include a rotatable shaft having an elongate main shaft body, and a plurality of laminations positioned along an axial extent of the main shaft body and defining a lamination stack, with each of the plurality of laminations having inner surface peripheries defining a substantially central aperture, and the plurality of central apertures forming a lamination stack channel to receive the shaft. The lamination stack is substantially devoid of or has no holes which accommodate clamping bars or bolts and thereby has a reduced mechanical stress concentration. A pair of clamping end plates are positioned on either of the respective ends of the lamination stack. The pair of end plates, for example, can be a pair of end plates having a shape, e.g., Belleville shape as understood by those skilled in the art, imparting a sufficient stiffness profile to maintain a substantially uniform preload on the lamination stack.

An internal clamping tube extends through the lamination stack channel and includes a main clamping tube body having a clamping tube channel substantially surrounding major surface portions of an axial extent of the main shaft body. The main clamping tube body is positioned between the major surface portions of the main shaft body and inner surface peripheries of the lamination stack forming the lamination stack channel and in contact with the inner surface peripheries of the lamination stack forming the lamination stack channel. The internal clamping tube defines an interface between the shaft and the lamination stack to accommodate an assembly methodology, as understood by those skilled in the art, selected from the group of: interference press fit, thermal shrink fit, and hydraulic assembly fit. The internal clamping tube includes a first tube end portion and a second tube end portion. The first tube end portion can include a radial clamping flange having an outer diameter substantially larger than the outer diameter of the main clamping tube body and substantially smaller than an outer diameter of the first clamping end plate. The second tube end portion can include a clamping fastener having an outer diameter substantially larger than the outer diameter of the main clamping tube body and substantially smaller than an outer diameter of the second clamping end plate. The radial clamping flange engages portions of the first clamping end plate and the clamping fastener engages portions of the second clamping end plate so that, in combination, they provide a clamping force against the pair of clamping end plates to thereby apply an axial preload to the lamination stack.

Embodiments of the present invention also provide methods of clamping laminations to form a rotor core, methods of assembling a rotor, and methods of disassembling a rotor of a high-speed electric machine. For example, a method of clamping a plurality of laminations to form a rotor core of a high-speed electric machine an embodiment of the present invention includes the step of assembling a plurality of laminations to form a lamination stack having a lamination stack channel, positioning a pair of end plates along opposing ends of the lamination stack, inserting an internal clamping tube through the lamination stack channel, and clamping the lamination stack between a first tube end portion and a second tube end portion of the internal clamping tube. Advantageously, the pair of end plates can have a sufficient stiffness profile to maintain a uniform or substantially uniform preload on the lamination stack as understood by those skilled in the art. Also advantageously, utilization of the internal clamping tube allows the lamination stack, i.e., each of the plurality of laminations of the lamination stack, to be devoid of holes to accommodate clamping bars or bolts and thereby reduces mechanical stress concentration and increases available lamination stack magnetic material. The internal clamping tube includes an internal clamping tube channel for receiving a rotatable shaft. In order to complete the assembly of the rotor, various insertion methodologies can be used. These include, for example, the interface press fit method, the thermal shrink fit method, and the tapered hydraulic assembly fit method. Regardless of which of these insertion methodologies are used, advantageously the internal clamping tube functions to more uniformly transfer the radial clamping load between the rotatable shaft and the lamination stack.

A method of assembling the rotor of a high speed electric machine utilizing the interference press fit methodology according to an embodiment of the present invention includes the step of forcibly inserting major surface portions of a rotary shaft into a clamping tube channel of a main clamping tube body of a clamping tube positioned within a lamination stack channel to compressively fix the major surface portions of the rotary shaft within the clamping tube channel.

A method of assembling the rotor of a high speed electric machine utilizing the thermal shrink fit methodology according to an embodiment of the present invention includes the step of heating an internal clamping tube positioned within a lamination stack channel extending through a lamination stack to expand a diameter of at least portions of the clamping tube channel to a value greater than a pre-insertion value of an outer diameter of major surface portions of a rotary shaft defining a heated value. The method also includes the steps of inserting the major surface portions of the rotary shaft into the clamping tube channel, and allowing the internal clamping tube to cool to reduce the diameter of at least portions of the clamping tube channel to a value less than the heated value, but equal to or greater than a pre-insertion diameter, to thereby compressively fix the major surface portions of the rotary shaft within the clamping tube channel.

A method of assembling the rotor of a high speed electric machine utilizing the tapered hydraulic assembly fit methodology according to an embodiment of the present invention includes the step of inserting major surface portions of a rotary shaft at least partially into a clamping tube channel of a clamping tube positioned within a lamination stack channel extending through a lamination stack. The method also includes the steps of injecting a fluid into the clamping tube channel through a conduit in the rotary shaft to expand a diameter of at least portions of the clamping tube channel to a value greater than a pre-insertion value of an outer diameter of the major surface portions of the rotary shaft defining a pressurized value, completing insertion of the major surface portions of the rotary shaft into the clamping tube channel, and reducing hydraulic pressure within the clamping tube channel to reduce the diameter of the at least portions of the clamping tube channel to a value less than the pressurized value, but equal to or greater than a pre-insertion diameter, to thereby compressively fix the major surface portions of the rotary shaft within the clamping tube channel.

A method of disassembling the rotor of a high speed electric machine utilizing the tapered hydraulic assembly fit methodology according to an embodiment of the present invention includes the steps of injecting fluid into a clamping tube channel of a clamping tube positioned within a lamination stack channel extending through a lamination stack to expand the diameter of at least portions of the clamping tube channel to a value sufficient to allow non-destructive removal of a pre-inserted rotary shaft from within the clamping tube channel, and removing the rotary shaft from within the clamping tube channel responsive to expanding the diameter of the at least portions of the clamping tube channel.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1 is a perspective view of a rotor assembly for an electric machine having an internal clamping tube, a lamination stack and a pair of end plates according to an embodiment of the present invention;

FIG. 2 is a perspective view of the rotor assembly of FIG. 1 with the shaft separated from the rotor core according to an embodiment of the present invention;

FIG. 3 is a perspective view of the rotor core of FIG. 2 with the shaft removed from the rotor core according to an embodiment of the present invention;

FIG. 4 is a perspective view of the rotor core of FIG. 3 taken along the 4-4 line according to an embodiment of the present invention;

FIG. 5 is an exploded perspective view of the rotor core of FIG. 3 according to an embodiment of the present invention;

FIG. 6 is an exploded a perspective view of the rotor core of FIG. 5 taken along the 6-6 line according to an embodiment of the present invention;

FIG. 7 is a perspective view of a lamination used to form a lamination stack of the rotor core of FIG. 3 according to an embodiment of the present invention;

FIG. 8 is a front plan view of the portion of the rotor core of FIG. 4 according to an embodiment of the present invention;

FIG. 9 is a cutaway perspective view of a rotor assembly having a lamination stack, a pair of Belleville shaped end plates, and an internal clamping tube according to an embodiment of the present invention;

FIG. 10 is a cutaway perspective view of a rotor assembly having a lamination stack, a pair of Belleville shaped end plates, a shaft, and an internal clamping tube having a tapered clamping tube channel according to an embodiment of the present invention;

FIGS. 11A and 11B illustrate a side plan view of two rotating structures, one with, and one without a plurality of radially spaced apart clamping boreholes extending through the rotating structure, along with an associated a pair of stress profile comparison charts illustrating that the peak stress in the rotating structure with holes is much greater than without holes, according to an embodiment of the present invention;

FIG. 12 is a schematic flow diagram illustrating a method of forming a rotor core according to an embodiment of the present invention;

FIG. 13 is a schematic flow diagram illustrating an interference fit method of assembling a rotor according to an embodiment of the present invention;

FIG. 14 is a schematic flow diagram illustrating a thermal shrink fit method of assembling a rotor according to an embodiment of the present invention;

FIG. 15 is a schematic flow diagram illustrating a tapered hydraulic assembly fit method of assembling a rotor according to an embodiment of the present invention; and

FIG. 16 is a schematic flow diagram illustrating a tapered hydraulic assembly fit method of disassembling a rotor according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art. Like numbers refer to like elements throughout. Prime notation, if used, indicates similar elements in alternative embodiments.

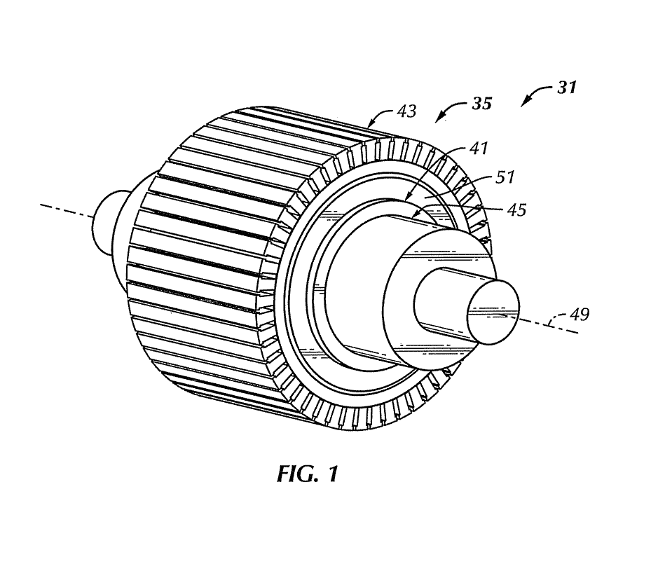

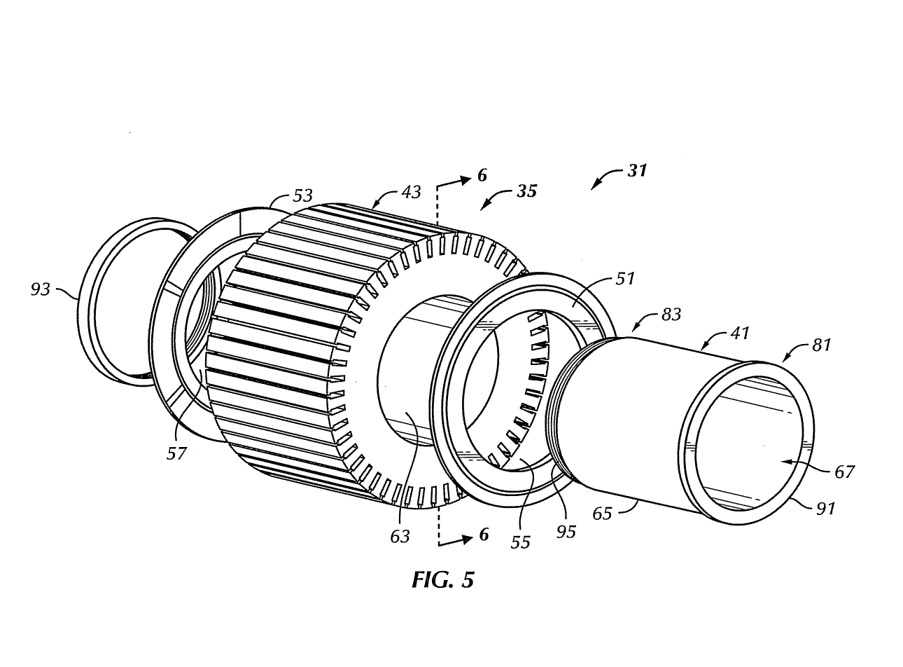

FIGS. 1-16 illustrate a rotor assembly 31 for a high-speed electric machine and methods of clamping a plurality of laminations 33 to form a rotor core 35 of a high-speed electrical machine according to embodiments of the present invention. In general, embodiments of a rotor assembly 31 includes a tube 41 (e.g., cylindrical) extending through a plurality of laminations 33 forming a rotor core lamination stack 43 and forming an interface between a rotatable shaft 45 and a rotor core lamination stack 43 for axially clamping the lamination stack 43 to the rotatable shaft 45, and for providing a protective pathway through the plurality of laminations 33 forming the lamination stack 43 for non-destructive insertion and extraction of a rotatable shaft 45. Embodiments of the tube 41 are in the form of an internal clamping tube 41, which functions in conjunction with a pair of end plates 51, 53, to provide an axial preload sufficient to enhance structural performance to allow use of the lamination stack 43 (axially clamped by the internal tube 41) in high power density and high-speed electric machines.

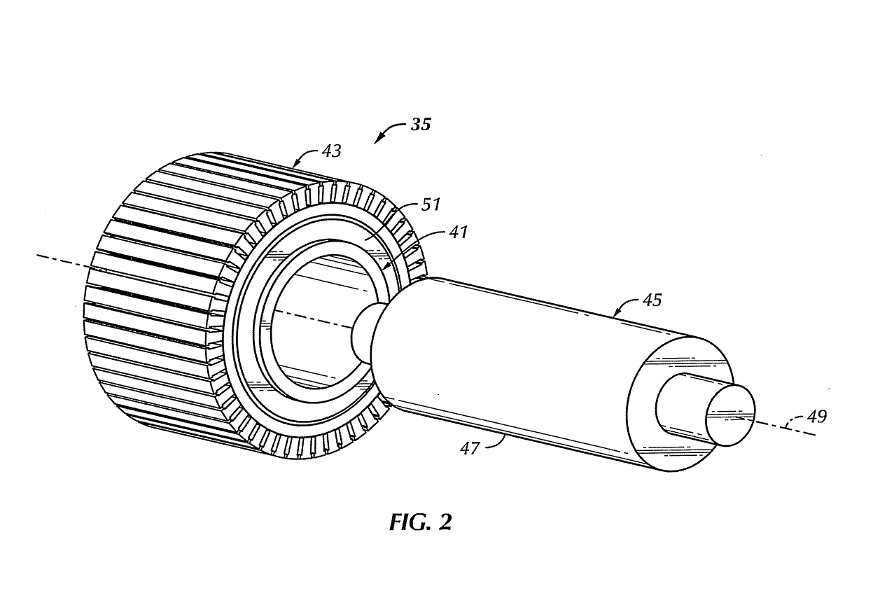

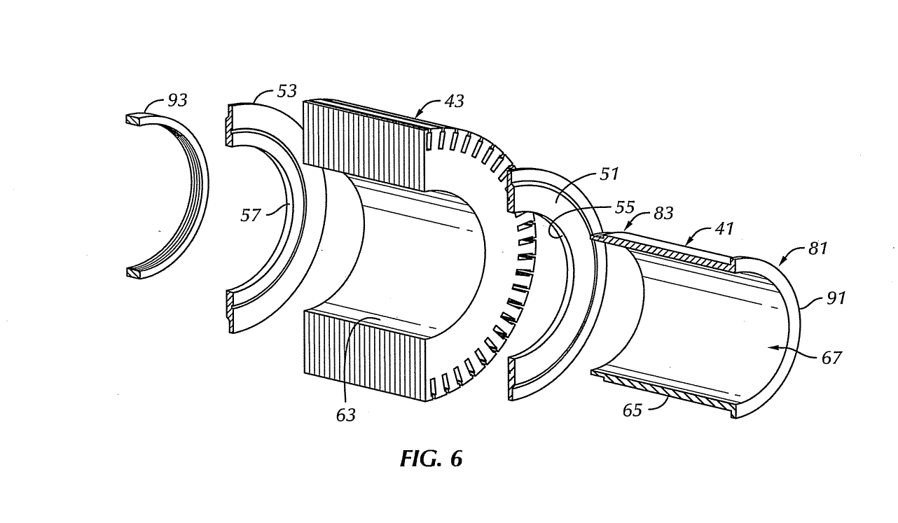

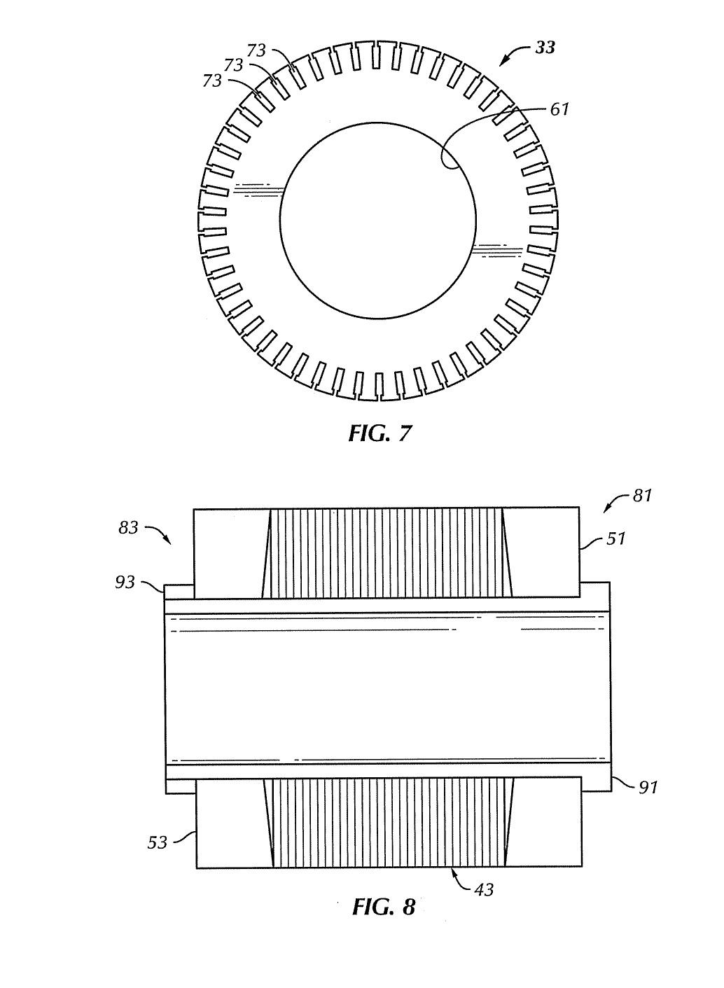

FIGS. 1-11 illustrate examples of an rotor assembly 31 for a high-speed electric machine according to embodiments of the present invention. FIG. 1 particularly illustrates a fully assembled rotor assembly 31 according to an exemplary embodiment of the present invention. As perhaps best shown in FIGS. 2-7, the rotor assembly 31 includes a shaft 45 including an elongate main shaft body 47 having a longitudinal axis 49 and multiple relatively thin laminations 33 (see, e.g. FIG. 7) formed of various forms of magnetic material/magnetically receptive material such as, for example, laminated iron, silicone steel, heat-treated alloy steel, or heat-treated high-strength low alloy steel, as known and understood by those skilled in the art, just to name a few. The laminations 33 are positioned along an axial extent of the shaft 45 and define a lamination stack 43. As perhaps best shown in FIG. 7, each lamination 33 includes inner surface peripheries defining a substantially central aperture 61. As perhaps best shown in FIGS. 5 and 6, the plurality of central apertures 61 form a lamination stack channel 63 adapted to receive the main body 47 of the shaft 45.

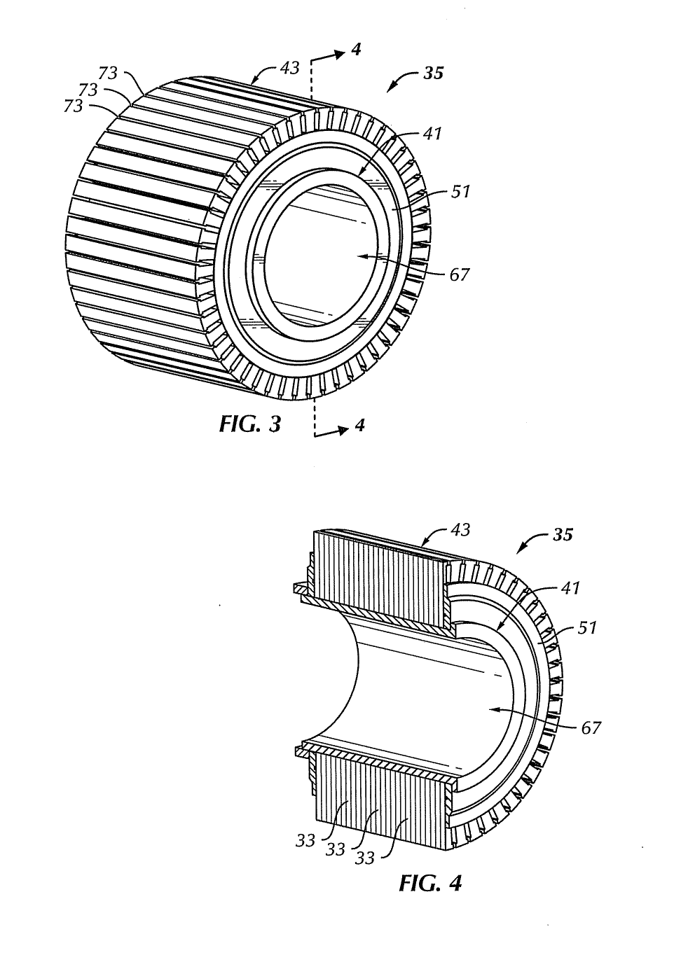

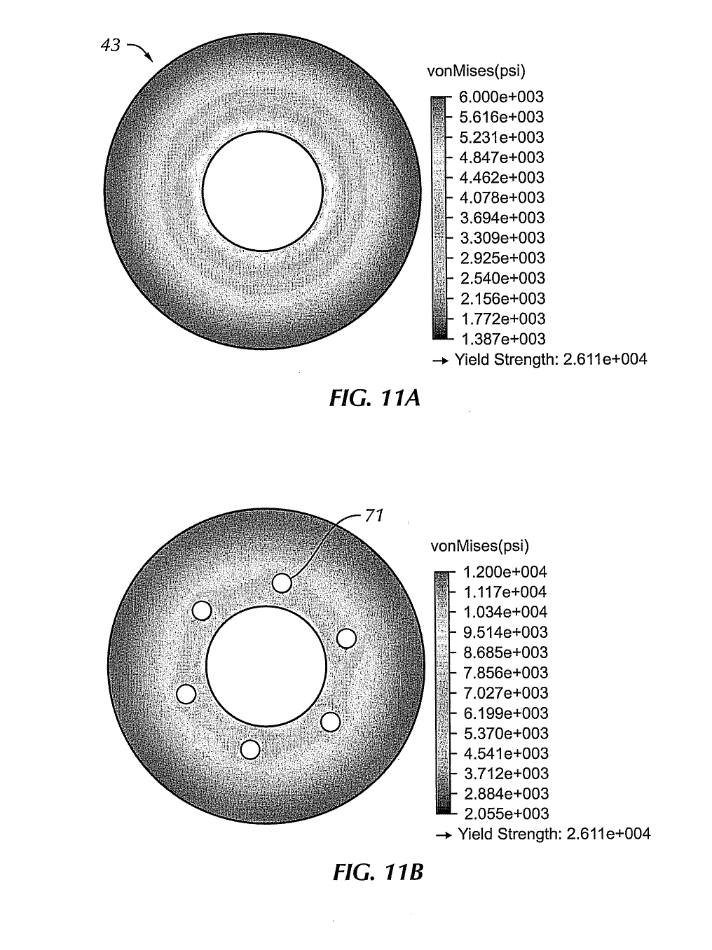

As perhaps best comparatively illustrated in FIGS. 11A and 11B, according to the exemplary embodiment of the present invention, the lamination stack 43 can be substantially devoid of any bores (thru-holes), which accommodate clamping bars, such as those employed in known industry rotor cores. Beneficially, as perhaps best shown in FIG. 11A, such absence of bores can significantly reduce mechanical stress concentrations, particularly those present around the bores 71 (FIG. 11B). Further, such absence of bores 71 provides for an increase in magnetic/magnetic-like material otherwise removed in order to form the bores 71. Similar to industry configuration, however, and as perhaps best shown in FIGS. 3 and 7, each of the laminations 33 can also include a plurality of axially extending recesses 73 positioned spaced apart around the entire circumference of the lamination 33 and generally extending the entire length of the lamination stack 43 to allow installation of axially oriented windings (see, e.g., FIG. 3).

As perhaps best shown in FIGS. 5 and 6, the assembly 31 includes the internal clamping tube 41 extending through the lamination stack channel 63 and in contact with the inner surface peripheries of the lamination stack 43 forming the lamination stack channel 63. In order to enhance positioning of the internal clamping tube 41 within the lamination stack 43, the lamination stack channel 63 can have a diameter substantially the same as an outer diameter of the main clamping tube body 65 of the clamping to 41.

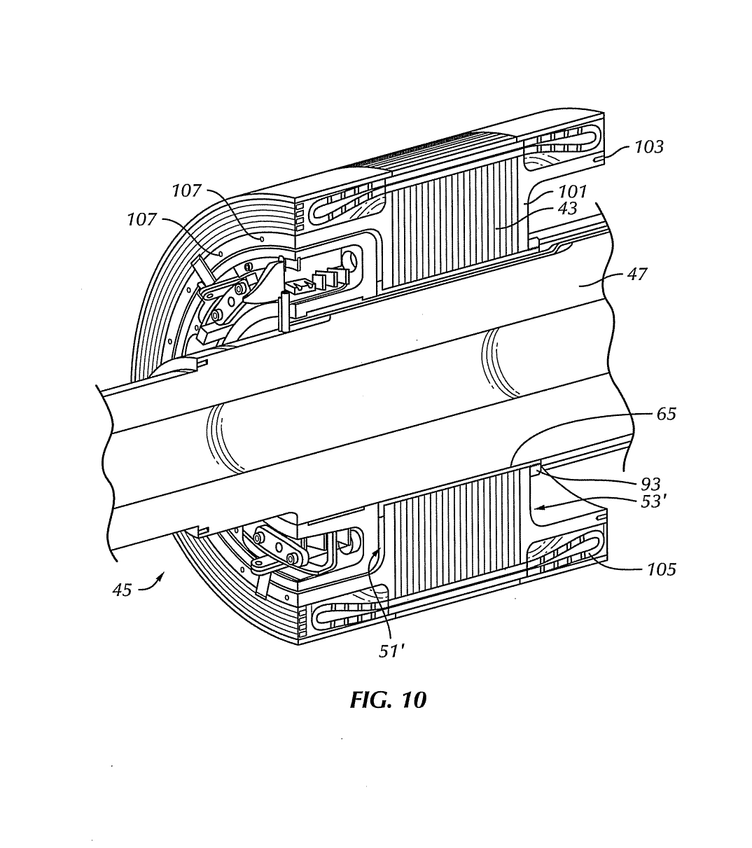

As perhaps best shown in FIGS. 3-6 and 9, the clamping tube 41 includes a main clamping tube body 65 having a clamping tube channel 67 adapted to receive the main shaft body 47 of the shaft 45. When assembled (see e.g., FIGS. 1 and 10), the inner surface peripheries of the clamping tube of body 65 forming the clamping tube channel 67 substantially surrounds major surface portions of an axial extent of the main shaft body 47, when positioned therein, with the main clamping tube body 65 positioned between the major surface portions of the main shaft body 47 and inner surface peripheries of the lamination stack 43 forming the lamination stack channel 63.

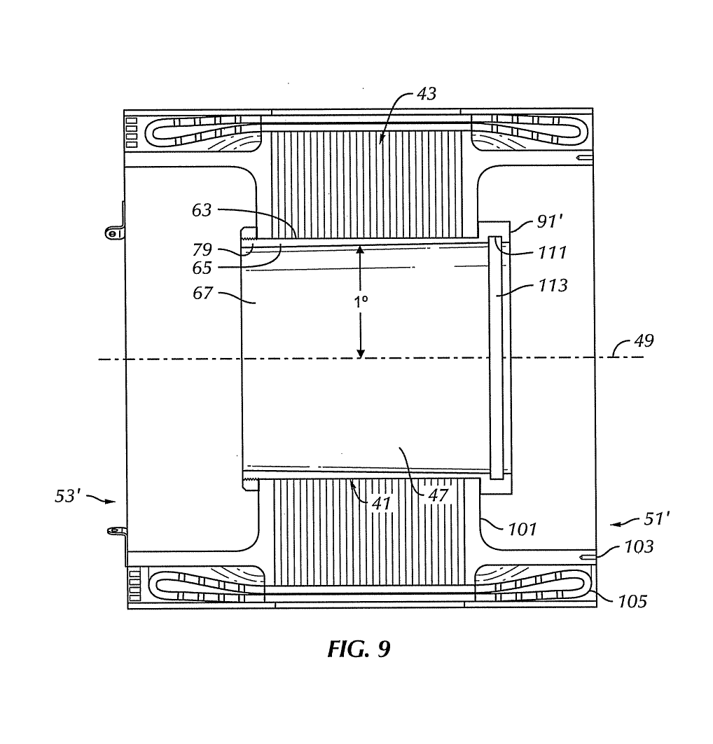

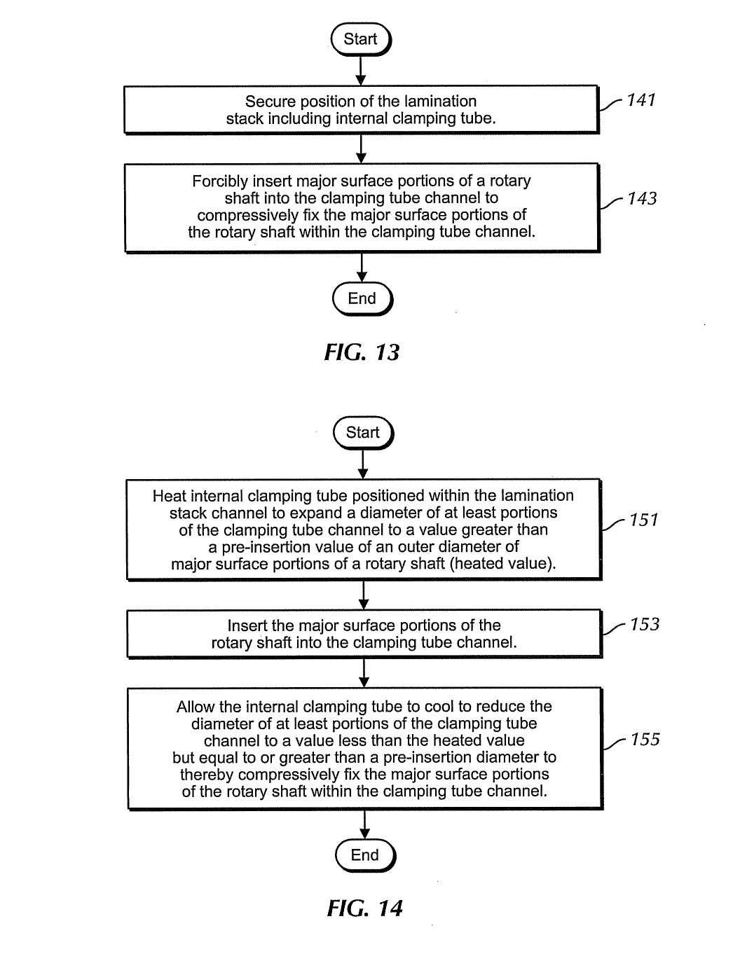

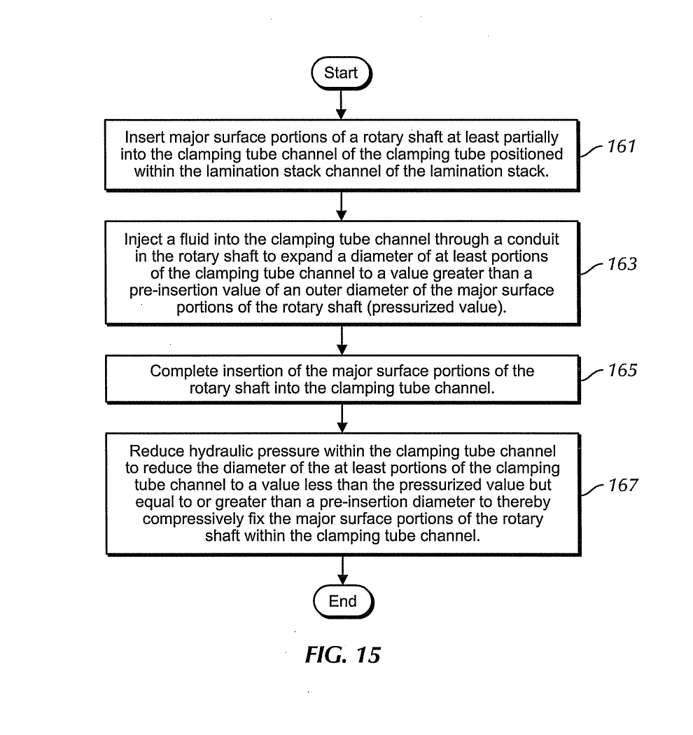

As perhaps best illustrated in FIG. 9, the outer diameter of the main shaft body 47 of the shaft 45 and the inner diameter of the internal clamping tube 41 are sized so that at least portions 79 of the clamping tube channel 67 have an inner diameter smaller than an outer diameter of the main shaft body 47, at least prior to insertion of the main shaft body 47 of the shaft 45 into the clamping tube channel 67. In this configuration, the clamping tube 41 provides the above described interface between the lamination stack 43 and the main shaft body 47 to allow for various friction-based installation methods such as, for example, the interference fit method (see, e.g., FIG. 13), the thermal shrink fit method (see, e.g., FIG. 14), and the hydraulic assembly fit method (see, e.g., FIG. 15), described in more detail later. Note, in various configurations, the outer diameter of the internal clamping tube 41 is substantially uniform, where the inner diameter is tapered, e.g., 1°, as illustrated. The significance of such taper will be described in more detail later, particularly with respect to the hydraulic assembly fit method of inserting the main body 47 of the shaft 45 through the clamping tube channel 67.

As noted above, embodiments of the internal clamping tube 41 not only provide an interface between the rotatable shaft 45 and the rotor core lamination stack 43 for axially clamping the lamination stack 43 via a radial application of force and for providing a protective pathway 67 through the lamination apertures 61 (lamination stack channel 63), for insertion and extraction of a rotatable shaft 45, embodiments of internal clamping tube 41, in conjunction with a pair of end plates 51, 53 (FIGS. 5 and 6), and 51′, 53′ (FIGS. 9 and 10) provide an axial preload sufficient to enhance performance and to allow use of the lamination stack 43 (axially clamped by the internal tube 41) to be used in high power density and high-speed electric machines.

Accordingly, as perhaps best illustrated in FIGS. 5 and 6, the rotor assembly 31 includes a first clamping end plate 51 positioned adjacent and in contact with a first end of the lamination stack 43, and a second clamping end plate 53 positioned adjacent and in contact with a second end of the lamination stack 43, axially opposite the position of first clamping end plate 51, to provide clamping of the lamination stack 43. Each clamping end plate can have a shape imparting a sufficient stiffness profile to impart the substantially uniform axial preload on the lamination stack 43. For example, each clamping end plate 51, 53, can have an outer diameter substantially the same as that of the non-machined portions of the laminations 33. Beneficially, this configuration enhances application of a substantially uniform axial preload, described in more detail later. Further, each clamping end plate 51, 53, has inner surface peripheries defining a substantially central clamping end plate aperture 55, 57 to receive the internal clamping tube, and thus, the main body 47 of the shaft 45.

Further, as with the plurality of laminations 33, according to the exemplary embodiments of the rotor assembly 31, neither of the clamping end plates 51, 53 require axial bores (thru-holes) for receiving axially extending bolts to clamp the lamination stack 43. Instead, as perhaps best shown in FIGS. 5, 6, and 8, the internal clamping tube 41 can include a first tube end portion 81 and a second tube end portion 83 configured to engage portions of the end plates 51, 53, (or 51′, 53′), to apply the axial preload. For example, the first tube end portion 81 can include a radial clamping flange 91 having an outer diameter substantially larger than the outer diameter of the main clamping tube body 65 and substantially smaller than an outer diameter of the first clamping end plate 51. The second tube end portion 83 can synergistically include a clamping faster 93 (when installed) and, e.g., threads 95, to receive the clamping faster 93. Similar to the radial clamping flange 91, the clamping fastener 93 can have an outer diameter also substantially larger than the outer diameter of the main clamping tube body 65 and substantially smaller than an outer diameter of the second clamping end plate 53. In combination, the radial clamping flange 91 engages portions of the first clamping end plate 51 and the clamping fastener 93 engages portions of the second clamping end plate 53 to thereby apply an axial preload to the lamination stack 43. In embodiments where the clamping faster 93 is threaded, e.g., a lock-nut, the axial preload can be readily adjusted to a preselected or desired value using various tools known to those skilled in the art such as, for example, a torque wrench. Regardless of the type of clamping faster used, beneficially, such value can be as low as 50-100 psi (or lower if desired) and as high as 500-700 psi or more, unachievable using conventional clamping methodologies.

Note, according to an alternate embodiment of the internal clamping tube (not shown), the radial clamping flange 91 can have an outer diameter matching that of the above-described first clamping end plate 51, and the clamping fastener 93 can have an outer diameter matching that of the above described second end plate 53. In such configuration, one or both of the clamping end plates 51, 53, can function as either a washer providing an interface between the respective radial clamping flange 91 and/or clamping fastener 93 and/or the main portion of the lamination stack 43, or can be removed, altogether, with the extended length radial clamping plate and the extended length clamping fastener, together, performing the functions of the pair of clamping end plates 51, 53.

As perhaps best shown in FIGS. 9 and 10, one or more end clamp plates 51′, 53′, having a shape, e.g., Belleville shape, as understood by those skilled in the art, are provided which impart a sufficient stiffness profile to maintain a substantially uniform preload on the lamination stack 43. These end clamp plates 51′, 53′ can include not only the end plate radial portion 101 positioned substantially perpendicular to the axis of rotation 49 and in contact with the lamination stack 43, but also, an end plate axial portion 103 extending substantially perpendicular to the end plate radial portion 101 and substantially parallel to the axis of rotation 49 of the main shaft body 47 of the 45 shaft and of the lamination stack 43, to support inner surface portions of, for example, an exciter armature 105, when used in an electrical machine, such as a generator. Beneficially, such axial extension or extensions 103 allow for compacting various other components under, e.g., the armature winding 105, as described in copending U.S. Patent Application No. 60/813,735, by Kitzmiller et al. titled “High Performance Rotating Rectifier for AC Generator Exciters”. Such axial extension or extensions 103 can also include or provide for the application of balance weights (not shown). Fasteners 107 for attaching such balance weights are shown more clearly, for example, in FIG. 10.

As perhaps best shown in FIG. 9, a radial clamping flange 91′ can include an annular recess 111 positioned to receive a seal 113 located at least partially within the annular recess 111 to provide a hydraulic seal between the internal clamping tube 41 and the main body 47 of shaft 45 during insertion of the shaft into the clamping tube channel 67 and extraction of the shaft 45 from the clamping tube channel 67.

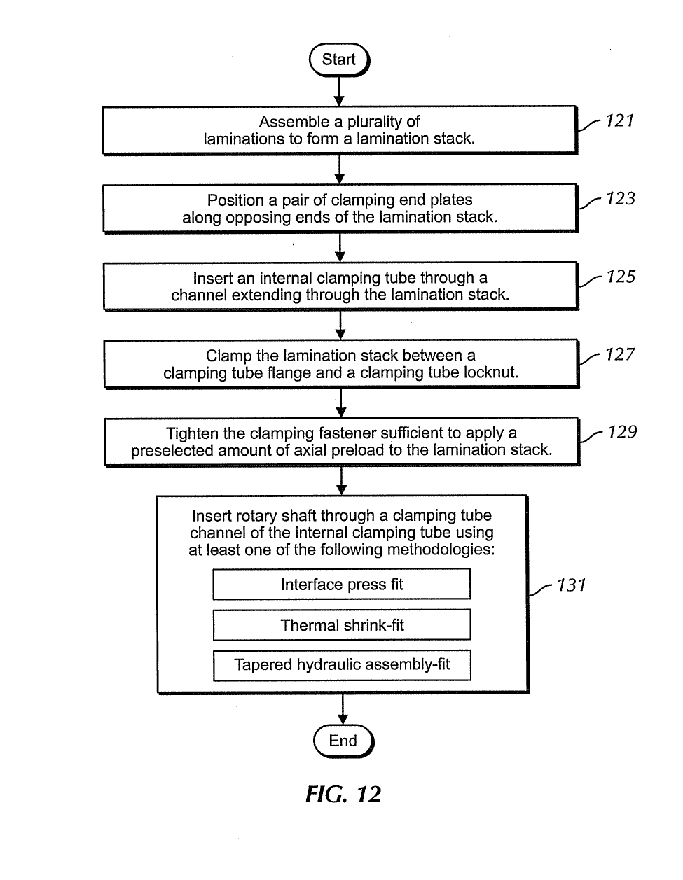

FIGS. 1-11 and 12-16 illustrate examples of methods of clamping a plurality of laminations 33 to form a rotor core 35 of a high-speed electrical machine according to embodiments of the present invention, along with examples methodologies of completing the rotor assembly 31. As noted above, FIG. 1 particularly illustrates a fully assembled rotor assembly 31 according to an exemplary embodiment of the present invention. FIG. 12 particularly illustrates a high-level flowchart showing an embodiment of a method of clamping a plurality of laminations 33 to form the rotor core 35 of the high-speed electrical machine. The illustrated method includes, for example, assembling a plurality of individual laminations 33 (block 121) such as those illustrated in FIG. 7 to form a lamination stack 43 such as that illustrated in FIGS. 3-6. Various methods of assembling a plurality of laminations are known to those skilled in the art. A new methodology of doing so, however, is described in copending PCT Patent Application No. ______ by Lewis et al. titled “Fabrication of Heat-Treated Laminations for High-Speed Rotors in Electrical Machines” and U.S. Patent Application No. 60/813,067, by Lewis et al. titled “Apparatus and Method to Clamp Laminations in a High Speed in Electric Machine.”

According to a preferred configuration, each of the plurality of laminations 33 of the lamination stack 43 is devoid of holes 71 to accommodate clamping bars (see, e.g., FIG. 11A-B), and thereby reduce mechanical stress concentration and maximize an amount of magnetic material available to the rotor core 35. Further, in order to reduce eddy currents, according to an embodiment of the lamination stack 43, as part of the assembly process, the lamination stack 43 can be subdivided into a first plurality of multilaminate sections (not shown) by a second plurality of insulating laminations (not shown) to thereby reduce eddy currents axially within the lamination stack 43. Use of such insulating laminations allows the lamination stack 43 to be assembled without the need for spacers (not shown) providing relatively axially-long, radially extending, air gaps between sections of the lamination stack 43 to reduce the eddy currents axially within the lamination stack 43. Such a configuration is disclosed, for example, in copending U.S. Provisional Patent Application No. 60/814,017, by Jordan et al. titled “Electric Machinery Laminated Cores With Insulating Laminations”.

The method can also include positioning a pair of end clamping plates 51, 53 or 51′, 53′, along opposite ends of the lamination stack 43 (block 123), as described above, and as perhaps best illustrated in FIGS. 5, 8, and 10. As noted above, each of the individual laminations 33 can include an aperture 61 which form a lamination stack channel 63 extending through the lamination stack 43 to receive a rotatable shaft 45, albeit via the internal clamping tube 41. Similarly, end plates 51, 53 or 51′, 53′ have such similar aperture. If either of the individual lamination apertures 61 or the apertures in the end clamping plates 51, 53 or 51′, 53′ do not have the desired diameter, either or both can be bored out, either before or after the lamination stack 43 is assembled.

The method further includes inserting an internal clamping tube 41 through the lamination stack channel 63 (block 125), and clamping the lamination stack 43 between the first tube end portion 81 and the second tube end portion 83 of the internal clamping tube 41 (block 127). Beneficially, the pair of clamping end plates 51, 53 or 51′, 53′ can have a sufficient stiffness profile to maintain a substantially uniform preload on the lamination stack 43 when clamped with the clamping tube 41.

As described previously, the first tube end portion 81 can include a radial clamping flange 91 having an outer diameter substantially larger than an outer diameter of a main clamping tube body 65 of the internal clamping tube 41, and the second tube end portion 83 can include clamping fastener threads 95 and a clamping faster 93 when positioned thereon, with each having an outer diameter substantially larger than the outer diameter of the main clamping tube body 65. As such, according to the exemplary embodiment of the method, the step of clamping the lamination stack 43 indicated at block 127 can include the steps of positioning the internal clamping tube 41 so that the radial clamping flange 91 engages portions of a first one of the pair of end plates 51, 51′, and threadingly connecting the clamping fastener 93 to the clamping fastener threads 95 of the second tube end portion 83 of the internal clamping tube 41.

Either as part of the clamping step or as a separate step, the method further includes tightening the clamping fastener 93 sufficient to apply a preselected amount of axial preload to the lamination stack 43 (block 129). The amount of axial preload is generally power density and rotation speed dependent. A range between approximately 50 psi and 700 psi has been found to be acceptable for various high power high-speed operations, with a range of 100 psi and 500 psi being preferred, and with a range of 400 psi and 500 psi being more preferred in operations utilizing rotor surface speeds in excess of 200 m/s and/or power densities greater than 2.5 kW/kg.

As described previously, the internal clamping tube 41 includes a main clamping tube body 65 having internal surface peripheries defining a clamping tube channel 67 adapted to receive major surface portions of a rotatable shaft 45. Accordingly, the method further includes the step of inserting the major surface portions of the shaft 45 into the clamping tube channel 67 (block 131). This step preferably includes the use of friction-based methodologies such as, for example, the interface press fit method, thermal shrink-fit method, and/or the tapered hydraulic assembly fit method.

In order to use friction-based clamping methods for clamping the rotatable shaft 45 and the lamination stack 43 together, the outer diameter of the major surface portions of the rotary shaft 45 have an outer diameter greater than a diameter of at least portions of the clamping tube channel 67 prior to insertion of the major surface portions of the shaft 45 into the clamping tube channel 67. That is, as perhaps best shown in FIG. 9, in a preferred configuration, the clamping tube 41 has a tapered thickness causing a constriction in the inner diameter of the clamping tube 41. Other methodologies of causing a variation between the outer diameter of the shaft 45 and the inner diameter of the clamping tube 41 are, however, within the scope of the present invention.

As noted above, there are various friction-based methodologies of inserting the shaft 45 into the core 35 including, e.g., the interface press fit method, thermal shrink-fit method, and/or the tapered hydraulic assembly fit method. As shown, for example, in the high-level flowchart illustrated in FIG. 13, the interference press fit method can include the steps of securing a position of the lamination stack 43 having internal clamping tube 41 installed therein (block 141), and forcibly inserting major surface portions of a shaft 45 into the clamping tube channel 67 of the main clamping tube body 65 of the clamping tube 41 (block 143) to expand the inner diameter of the clamping tube channel 67 and/or to shrink the outer diameter of the shaft 45 adjacent to a contact point within the tube 41 to compressively fix the major surface portions of the shaft 45 within the clamping tube channel 67.

As shown, for example, in the high-level flowchart illustrated in FIG. 14, the thermal shrink fit method can include the steps of heating an internal clamping tube 41 (block 151) positioned within the lamination stack channel 63 extending through the lamination stack 43 to expand the diameter of at least portions of the clamping tube channel 63 to a value greater than a pre-insertion value of an outer diameter of major surface portions of the shaft 45 (defining a heated value) to also expand the diameter of the individual apertures 61 of each of the plurality of laminations 33 forming the lamination stack 43. The method also includes the steps of inserting the major surface portions of the shaft 45 into the clamping tube channel 67 (block 153), followed by allowing the internal clamping tube 41 to cool to reduce the diameter of at least portions of the clamping tube channel 67 to a value less than the heated value but equal to or greater than a pre-insertion diameter to thereby compressively fix the major surface portions of the shaft 45 within the clamping tube channel 67 (block 155).

Beneficially, because of the use of the internal clamping tube 41, embodiments of the method allow utilization of the hydraulic assembly fit method, not otherwise available in a rotor core utilizing a laminated stack configuration. Accordingly, as shown, for example, in the high-level flowchart illustrated in FIG. 15, the tapered hydraulic assembly fit method can include the step of inserting major surface portions of the shaft 45 at least partially into the clamping tube channel 67 of the clamping tube 41 (block 161); generally, until the shaft 45 cannot be inserted without a preselected amount of axial force. The method also includes the steps of injecting a substantially non-compressible fluid (not shown) into the clamping tube channel 67 through a conduit (not shown) in the main body 47 of the shaft 45 (block 163) to expand a diameter of at least portions of the clamping tube channel to a value greater than a pre-insertion value of an outer diameter of the major surface portions of the shaft 45 (defining a pressurized value), and completing insertion of the major surface portions of the main body 47 of the shaft 45 into the clamping tube channel 67 (block 165). The method further includes the step of then reducing the hydraulic pressure within the clamping tube channel 67 (block 167) to reduce the diameter of the at least portions of the clamping tube channel 67 to a value less than the pressurized value, but generally equal to or greater than a pre-insertion diameter, to thereby allow portions of the body 65 of the clamping tube 41 to tighten around the shaft 45. This tightening advantageously serves to compressively fix the main body 47 of the shaft 45 within the clamping tube channel 67, and therefore, within the lamination stack 43.

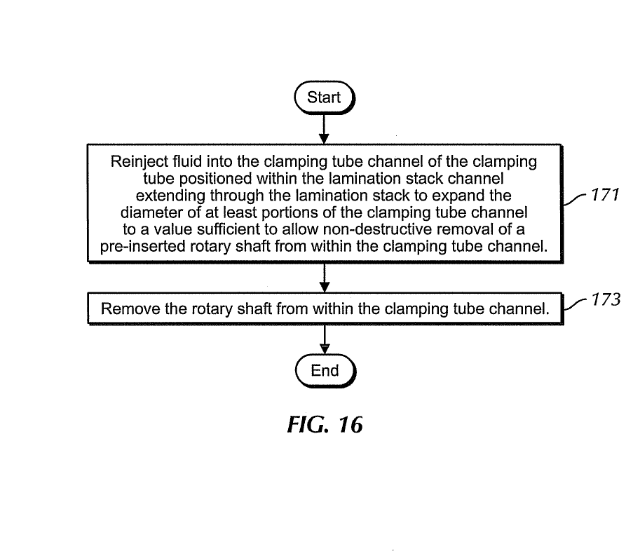

As part of the assembly process of the above described rotatable assembly 31, particularly where the tapered hydraulic assembly fit method is used, the process can include disassembling the rotor core 35 to allow for individual components to be replaced or recycled. As shown in the high-level flowchart illustrated in FIG. 16, the method of disassembling the rotor assembly 31 can include the steps of injecting fluid into the clamping tube channel 67 of the clamping tube 41 positioned within the lamination stack channel 63 (block 171) to expand the diameter of at least portions of the clamping tube channel 67 to a value sufficient to allow non-destructive removal of a pre-inserted shaft 45 from within the clamping tube channel 67, i.e., value is equal to or greater than an uncompressed value of the outer diameter of the major surface portions of the shaft 45; and removing the shaft 45 from within the clamping tube (block 173) channel 67 responsive to expanding the diameter of the at least portions of the clamping tube channel 67.

This Application is related to U.S. Patent Application No. 60/813,067, by Werst et al. titled “Apparatus and Method for Clamp Laminations in a High Speed in Electric Motors” filed Jun. 13, 2006; U.S. patent application Ser. No. ______, by Kitzmiller et al. titled “Rotor Assembly and Method of Assembling a Rotor of a High Speed Electric Machine”, filed Jun. 13, 2007; U.S. Patent Application No. 60/813,735, by Kitzmiller et al. titled “High Performance Rotating Rectifier for AC Generator Exciters”, filed Jun. 14, 2006; PCT Patent Application No. ______ by Lewis et al. titled “Fabrication of Heat-Treated Laminations for High-Speed Rotors in Electrical Machines”, filed Jun. 13, 2007; U.S. Patent Application No. 60/813,680, by Lewis et al. titled “Fabrication of Heat-Treated Laminations for High-Speed Rotors in Electrical Machines,” filed Jun. 14, 2006; and U.S. Patent Application No. 60/814,017, by Jordan et al. titled “Electric Machinery Laminated Cores With Insulating Laminations”, filed Jun. 15, 2006, each incorporated by reference in their entireties.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification. For example, although the rotor core was described in the exemplary embodiment as being formed of a plurality of laminations, a solid core generally formed of various forms of core material including both metallic, e.g., iron, and nonmetallic, e.g., ferrite ceramic, material. Other core materials can include carbonyl iron, iron powder, etc.

That claimed is:

1. A rotor assembly for a high speed electric machine, comprising:
a shaft including an elongate main shaft body having a longitudinal axis;
a plurality of laminations positioned along an axial extent of the shaft and defining a lamination stack, each lamination having inner surface peripheries defining a substantially central aperture, the plurality of central apertures forming a lamination stack channel to receive the shaft; and
an internal clamping tube extending through the lamination stack channel and including a main clamping tube body having a clamping tube channel substantially surrounding major surface portions of an axial extent of the main shaft body, the main clamping tube body positioned between the major surface portions of the main shaft body and inner surface peripheries of the lamination stack forming the lamination stack channel and in contact with the inner surface peripheries of the lamination stack forming the lamination stack channel to thereby provide an interface between the lamination stack and the shaft, the lamination stack channel having a diameter substantially the same as an outer diameter of the main clamping tube body, at least portions of the clamping tube channel having an inner diameter smaller than an outer diameter of the main shaft body prior to insertion of the main shaft body of the shaft into the clamping tube channel.

2. A rotor assembly as defined in claim 1, further comprising:
a first clamping end plate positioned on a first end of the lamination stack and having inner surface peripheries defining a substantially central first clamping end plate aperture to receive the internal clamping tube; and
a second clamping end plate positioned on a second end of the lamination stack and having inner surface peripheries defining a substantially central second clamping end plate aperture to receive the internal clamping tube, the position of the second clamping end plate axially opposite the position of first clamping end plate to provide clamping of the lamination stack.

3. A rotor assembly as defined in claim 2, wherein the internal clamping tube includes a first tube end portion and a second tube end portion, the first tube end portion including a radial clamping flange having an outer diameter substantially larger than the outer diameter of the main clamping tube body and substantially smaller than an outer diameter of the first clamping end plate, the second tube end portion including a clamping fastener having an outer diameter substantially larger than the outer diameter of the main clamping tube body and substantially smaller than an outer diameter of the second clamping end plate, the radial clamping flange engaging portions of the first clamping end plate and the clamping fastener engaging portions of the second clamping end plate to thereby apply an axial preload to the lamination stack.

4. A rotor assembly as defined in claim 2, wherein the axial preload is a substantially uniform preload, and wherein the first and the second clamping end plates comprise a pair of clamping end plates having a shape imparting a sufficient stiffness profile to impart the substantially uniform axial preload on the lamination stack, the pair of end plates also being positioned so that the internal clamping tube is positioned between the shaft and the inner surface peripheries of the pair of end plates.

5. A rotor assembly as defined in claim 3, wherein the clamping fastener is a clamping lock-nut threadingly connected to the second tube end portion of the internal clamping tube, and wherein the axial preload is set to at least 200 psi.

6. A rotor assembly as defined in claim 1, wherein the outer diameter of the main clamping tube body is substantially uniform, and wherein the internal clamping tube includes a first tube end portion and a second tube end portion, the second tube end portion having an inner diameter that is substantially smaller than an inner diameter of the first tube end portion and the outer diameter of at least portions of the shaft prior to insertion thereof into the clamping tube channel.

7. A rotor assembly as defined in claim 6, wherein the radial clamping flange includes an annular recess, and wherein the rotor assembly further comprises a seal positioned at least partially within the annular recess to provide a hydraulic seal between the internal clamping tube and the shaft during at least one on the following: insertion of the shaft into the clamping tube channel and extraction of the shaft from the clamping tube channel.

8. A rotor assembly as defined in claim 2, wherein the first and the second clamping end plates each include an end plate radial portion positioned substantially perpendicular to the axis of rotation and in contact with the lamination stack, and an end plate axial portion extending substantially perpendicular to the end plate radial portion and substantially parallel to the axis of rotation to support inner surface portions of an exciter armature.

9. A rotor assembly as defined in claim 1, wherein the lamination stack is substantially devoid of holes which accommodate clamping bars to thereby reduce mechanical stress concentration.

10. A rotor assembly as defined in claim 1, wherein the internal clamping tube defines an interface between the shaft and inner portion of the lamination stack to accommodate any one of the following assembly methods: interference press fit, thermal shrink fit, and hydraulic assembly fit.

11. A rotor assembly comprising:
a plurality of laminations adapted to be positioned along an axial extent of a shaft having an elongate main shaft body having a longitudinal axis and defining a lamination stack, each lamination having inner surface peripheries defining a substantially central aperture, the plurality of central apertures forming a lamination stack channel to receive the shaft; and
an internal clamping tube extending through the lamination stack channel and including a main clamping tube body having a clamping tube channel substantially surrounding major surface portions of an axial extent of the main shaft body when the shaft is positioned therethrough, the main body positioned in contact with inner surface peripheries of the lamination stack forming the lamination stack channel to thereby provide an interface between the lamination stack and the shaft when positioned therethrough, the lamination stack channel having a diameter substantially the same as an outer diameter of the main clamping tube body, at least portions of the clamping tube channel having an inner diameter smaller than an outer diameter of the main shaft body prior to insertion of the shaft into the clamping tube channel.

12. A rotor assembly as defined in claim 11, further comprising:
a first clamping end plate positioned on a first end of the lamination stack and having inner surface peripheries defining a substantially central first clamping end plate aperture to receive the internal clamping tube; and
a second clamping end plate positioned on a second end of the lamination stack and having inner surface peripheries defining a substantially central second clamping end plate aperture to receive the internal clamping tube, the position of the second clamping end plate axially opposite the position of first clamping end plate to provide clamping of the lamination stack.

13. A rotor assembly as defined in claim 12, wherein the internal clamping tube includes a first tube end portion and a second tube end portion, the first tube end portion including a radial clamping flange having an outer diameter substantially larger than the outer diameter of the main clamping tube body, the second tube end portion including a clamping fastener having an outer diameter substantially larger than the outer diameter of the main clamping tube body, the radial clamping flange engaging portions of the first clamping end plate and the clamping fastener engaging portions of the second clamping end plate to thereby apply an axial preload to the lamination stack.

14. A rotor assembly as defined in claim 12,
wherein the axial preload is a substantially uniform preload, wherein the first and the second clamping end plates comprise a pair of clamping end plates having a shape imparting a sufficient stiffness profile to impart the substantially uniform axial preload on the lamination stack, the pair of end plates also being positioned so that the internal clamping tube is positioned between the shaft and the inner surface peripheries of the pair of end plates;
wherein the axial preload is set to at least 200 psi; and
wherein a subset of the plurality of laminations comprise heat-treated alloy steel laminations.

15. A rotor assembly as defined in claim 11,
wherein the outer diameter of the main clamping tube body is substantially uniform;
wherein the internal clamping tube includes a first tube end portion and a second tube end portion, the second tube end portion having an inner diameter that is substantially smaller than an inner diameter of the first tube end portion and the outer diameter of at least portions of the shaft prior to insertion thereof into the clamping tube channel;
wherein the radial clamping flange includes an annular recess, and
wherein the assembly further comprises a seal positioned at least partially within the annular recess to provide a hydraulic seal between the internal clamping tube and the shaft during at least one on the following: insertion of the shaft into the clamping tube channel and extraction of the shaft from the clamping tube channel.

16. A rotor assembly as defined in claim 11, wherein the lamination stack is substantially devoid of holes which accommodate clamping bars to thereby reduce mechanical stress concentration.

17. A rotor assembly as defined in claim 11, wherein a plurality of the laminations comprise heat-treated high-strength low alloy steel.

18. A rotor assembly as defined in claim 11, wherein the lamination stack is subdivided into a first plurality of multilaminate sections by a second plurality of insulating laminations to thereby reduce eddy currents axially within the lamination stack, and wherein the lamination stack is devoid of a radial air gap providing a ventilation path to cool the assembly and to reduce eddy currents axially within the lamination stack.

19. A method of clamping a plurality of laminations to form a rotor core of a high-speed electrical machine, the method comprising:
assembling a plurality of laminations to define a lamination stack, each lamination having inner surface peripheries defining an aperture, the plurality of apertures forming a lamination stack channel;
inserting an internal clamping tube through the lamination stack channel, the internal clamping tube having a first tube end portion and a second tube end portion; and
clamping the lamination stack between the first tube end portion and the second tube end portion of the internal clamping tube.

20. A method as defined in claim 19, further comprising the step of positioning a pair of clamping end plates along opposing ends of the lamination stack.

21. A method as defined in claim 20, wherein the pair of clamping end plates have a sufficient stiffness profile to maintain a substantially uniform preload on the lamination stack when clamped with the clamping tube.

22. A method as defined in claim 20, wherein the first tube end portion includes a radial clamping flange having an outer diameter substantially larger than an outer diameter of a main clamping tube body of the internal clamping tube, the second tube end portion including clamping fastener threads, and wherein the step of clamping the lamination stack includes the steps of:
positioning the internal clamping tube so that the radial clamping flange engages portions of a first one of the pair of end plates;
threadingly connecting the clamping fastener to the clamping fastener threads of the second tube end portion of the internal clamping tube, the clamping fastener having an outer diameter substantially larger than the outer diameter of the main clamping tube body; and
tightening the clamping fastener sufficient to apply a preselected amount of axial preload to the lamination stack.

23. A method as defined in claim 22, wherein each of the plurality of laminations of the lamination stack is devoid of holes to accommodate clamping bars and thereby reduce mechanical stress concentration; and wherein the preselected axial preload is between 100 psi and 500 psi.

24. A method as defined in claim 19, wherein the internal clamping tube includes a main clamping tube body having internal surface peripheries defining a clamping tube channel adapted to receive major surface portions of a rotatable shaft, and wherein an outer diameter of the major surface portions of the rotatable shaft have an outer diameter greater than a diameter of at least portions of the clamping tube channel prior to insertion of the major surface portions of the rotatable shaft into the clamping tube channel, the method further comprising the step of inserting the major surface portions of the rotatable shaft into the clamping tube channel using at least one of the following: interface press fit, thermal shrink fit, and tapered hydraulic assembly fit.

25. A method of assembling a rotor of a high-speed electrical machine, comprising the step of forcibly inserting major surface portions of a rotatable shaft into a clamping tube channel of a main clamping tube body of a clamping tube positioned within a lamination stack channel extending through a lamination stack comprised of a plurality of laminations to compressively fix the major surface portions of the rotatable shaft within the clamping tube channel, at least portions of the clamping tube channel having a larger diameter than a pre-insertion diameter of the at least portions of the clamping tube channel responsive to the insertion.

26. A method of assembling a rotor of a high-speed electrical machine, comprising the steps of:
heating an internal clamping tube positioned within a lamination stack channel extending through a lamination stack comprised of a plurality of laminations to expand a diameter of at least portions of the clamping tube channel to a value greater than a pre-insertion value of an outer diameter of major surface portions of a rotatable shaft defining a heated value;
inserting the major surface portions of the rotatable shaft into the clamping tube channel; and
allowing the internal clamping tube to cool to reduce the diameter of at least portions of the clamping tube channel to a value less than the heated value but equal to or greater than a pre-insertion diameter to thereby compressively fix the major surface portions of the rotatable shaft within the clamping tube channel, the diameter of the at least portions of the clamping tube channel maintaining the value less than the heated value but equal to or greater than the pre-insertion diameter responsive to a combination of the insertion and the cooling.

27. A method of assembling a rotor of a high-speed electrical machine, comprising the steps of:
inserting major surface portions of a rotatable shaft at least partially into a clamping tube channel of a clamping tube positioned within a lamination stack channel extending through a lamination stack comprised of a plurality of laminations;
injecting a fluid into the clamping tube channel through a conduit in the rotatable shaft to expand a diameter of at least portions of the clamping tube channel to a value greater than a pre-insertion value of an outer diameter of the major surface portions of the rotatable shaft defining a pressurized value;
completing insertion of the major surface portions of the rotatable shaft into the clamping tube channel; and
reducing hydraulic pressure within the clamping tube channel to reduce the diameter of the at least portions of the clamping tube channel to a value less than the pressurized value but equal to or greater than a pre-insertion diameter to thereby compressively fix the major surface portions of the rotatable shaft within the clamping tube channel, the diameter of the at least portions of the clamping tube channel maintaining the value less than the pressurized value but equal to or greater than the pre-insertion diameter responsive to a combination of the completing insertion and the reducing hydraulic pressure.

28. A method of disassembling a rotor of a high-speed electrical machine, comprising the steps of:
injecting fluid into a clamping tube channel of a clamping tube positioned within a lamination stack channel extending through a lamination stack comprised of a plurality of laminations to expand the diameter of at least portions of the clamping tube channel to a value sufficient to allow non-destructive removal of a pre-inserted rotatable shaft from within the clamping tube channel; and
removing the rotatable shaft from within the clamping tube channel responsive to expanding the diameter of the at least portions of the clamping tube channel.
